(19) United States
(12) Patent Application Publication
(10) Pub. No.: US 2010/0071054 A1
(43) Pub. Date: Mar. 18, 2010

(54) NETWORK SECURITY APPLIANCE

(75) Inventor: Steve R. Hart, Carlsbad, CA (US)

Correspondence Address: TOWNSEND AND TOWNSEND AND CREW LLP;VIASAT, INC. (CLIENT #017018), TWO EMBARCADERO CENTER, 8TH FLOOR, SAN FRANCISCO, CA, 94111, US

(73) Assignee: ViaSat, Inc., Carlsbad, CA (US)

(21) Appl. No.: 12/431,190

(22) Filed: Apr. 28, 2009

Related U.S. Application Data
(60) Provisional application No. 61/053,593, filed on May 15, 2008.
(60) Provisional application No. 61/049,412, filed on Apr. 30, 2008.

(51) Int. Cl. H04L 9/00; G06F 21/00

(52) U.S. Cl. 726/13; 713/153; 726/14; 726/23

(57) ABSTRACT

Systems and methods for combating and thwarting attacks by cybercriminals are provided. Network security appliances interposed between computer systems and public networks, such as the Internet, are configured to perform defensive and/or offensive actions against botnets and/or other cyber threats. According to some embodiments, network security appliances may be configured to perform coordinated defensive and/or offensive actions with other network security appliances.

### CROSS-REFERENCES TO RELATED APPLICATIONS

This application claims the benefit of priority to U.S. Provisional Application No. 61/049,412 (Attorney Docket No. 017018-018000US), titled “Network Security Appliance,” filed Apr. 30, 2008, and to U.S. Provisional Application No. 61/053,593 (Attorney Docket 017018-018010US), titled “Network Security Appliance,” filed May 15, 2008, the content of which is hereby incorporated by reference for all purposes.

### BACKGROUND OF THE INVENTION

Criminals have been able to gain control of millions of personal computer systems (PCs) for various nefarious activities, such as generating spam messages, propagating viruses and worms used to compromise additional computer systems, stealing personal information for identity theft, and launching denial of service (DOS) attacks on computer systems. Networks of compromised machines (also known as “zombies”) are referred to as botnets. A botnet may include hundreds, thousands, or even millions of zombie computer systems that are under the control of the botnet. For example, the “Storm” botnet has been estimated to control as many as one to two million zombie computer systems to fewer than 160,000 zombie computer systems. Another botnet, the “bobax” or “Kraken” network has been estimated to control between 160,000 and 400,000 zombie computer systems, and the “Srizbi” network has been estimated to control 315,000 zombie computer systems.

Cybercriminals in control of botnets often offer the services of the botnets to the highest bidder. Often the botnet may be used to launch attacks, such as denial of server (DOS) attacks, on the computer systems of government and/or private entities. Terrorist groups may also harness botnets to stage attacks against government information systems and/or other critical infrastructure, such as power plants, air traffic control computer systems, and particularly well-funded terrorist organizations may have the resources to capture their own network of zombie computer systems for use in staging attacks. The size of a botnet can be quite extensive. Cyber terrorist groups may have as many as millions of zombie computer systems under their control, providing the terrorist groups with significantly more computing resources at their disposal for staging attacks the government and/or private entities currently often have at their disposal for thwarting such attacks.

### BRIEF SUMMARY OF THE INVENTION

Systems and methods for combating and thwarting attacks by cybercriminals are provided. Network security appliances interposed between computer systems and public networks, such as the Internet, are configured to perform defensive and/or offensive actions against botnets and/or other cyber threats. According to some embodiments, network security appliances may be configured to perform coordinated defensive and/or offensive actions with other network security appliances.

According to an embodiment of the present invention, a network security appliance is provided. The network security appliance is interposed between a computer system and a public network, such as the Internet. The network security appliance is configured to: receive, via a secure connection over the public network, digitally signed and encrypted threat information for identifying malicious content and activities; validate the signature of the security related information; decrypt the security related information; update a secured memory of the network security appliance with the threat information; and analyze data traffic between the computer system and the public network to identify malicious content using the threat information.

According to another embodiment of the present invention, a method of operating a network security appliance is provided. The network security appliance is interposed between a computer system and a public network, such as the Internet. The method includes: receiving, via a secure connection over the public network, digitally signed and encrypted threat information for identifying malicious content and activities; validating the signature of the security related information; decrypting the security related information; updating a secured memory of the network security appliance with the threat information; and analyzing data traffic between the computer system and the public network to identify malicious content using the threat information.

According to yet another embodiment of the present invention, a computer network is provided. The computer network comprises a management system communicationally coupled to a public network, and a plurality of network security appliances. The network security appliances each being interposed between a computer system and the public network. The management server is configured to transmit security-related information and commands to the plurality of network security appliances, and the management server is further configured to receive security-related information and network data from the plurality of network security appliances.

### BRIEF DESCRIPTION OF THE DRAWINGS

FIG. 1 is a block diagram of a computer network that may be used to take defensive and/or offensive actions against cyber threats according to an embodiment of the present invention.

FIG. 2 is a block diagram of a security appliance according to an embodiment of the present invention.

FIG. 3 is a block diagram illustrating a user interface for tracking activity of a security appliance according to an embodiment of the present invention.

FIG. 4 is a high level flow diagram of a method for analyzing packets in a security appliance operating in a standalone security appliance mode according to an embodiment of the present invention.

FIG. 5 is a high level flow diagram of a method for analyzing packets in a security appliance operating in a managed defender mode according to an embodiment of the present invention.

FIG. 6 is a high level flow diagram of a method for analyzing packets in a security appliance operating in a cooperative defender mode according to an embodiment of the present invention.

FIG. 7 is a high level flow diagram of a method for transmitting control commands to security appliances according to an embodiment of the present invention.

FIG. 8 is a high level flow diagram of a method for operating a security appliance to respond to control commands from management servers according to an embodiment of the present invention.

FIG. 9 is a high level flow diagram of a method for operating a security appliance to pose as a computer that is a member of a botnet according to an embodiment of the present invention.

FIG. 10 is a high level flow diagram of a method for updating the security information of a security appliance according to an embodiment of the present invention.

### DETAILED DESCRIPTION OF THE INVENTION

Systems and methods are provided that enable governments and/or private entities to effectively fight back against botnets and other cyber threats. A large, widely-distributed network of computer systems and network security appliances is provided to defend against swarm attacks staged using zombie computer systems under control of a botnet and to mount effective counter-attacks on these botnets. According to some embodiments of the present invention, the computer systems comprising this widely distributed network are physically distributed over a wide geographic area and are assigned different network addresses to minimize the risk of denial of service attacks and/or other types of attack from being able to cripple the entire network of computers used to defend against and/or mount attacks against botnets.

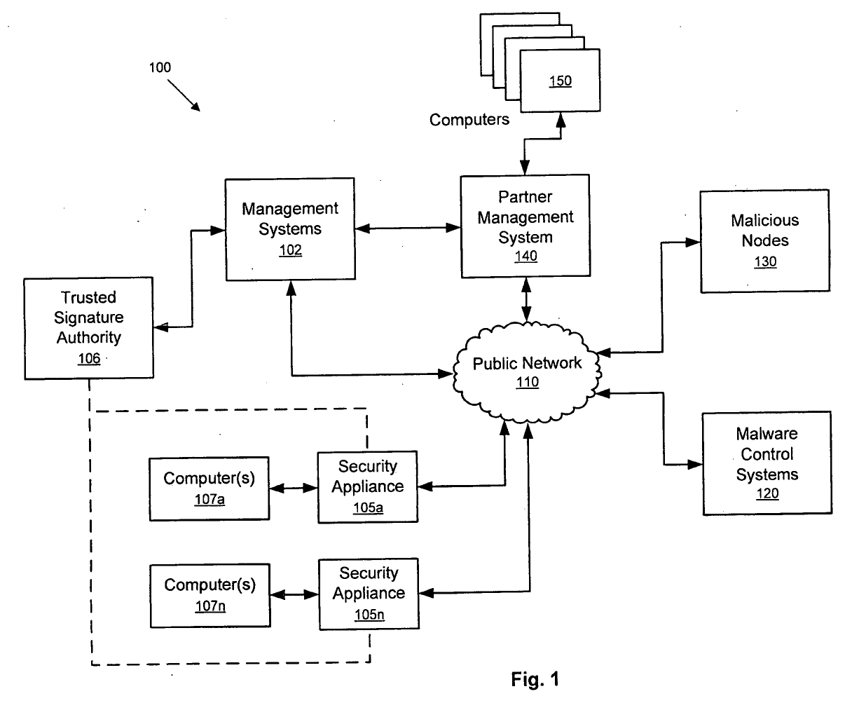

FIG. 1 is a block diagram of a computer network 100 that may be used to take defensive and/or offensive actions against a cyber threat according to an embodiment of the present invention. Network 100 includes a plurality of security appliances 105(a)-105(n). Each security appliance is connected to a public network 110, such as the Internet, and are interposed between one or more computer systems 107(a)-107(n) and public network 110. Computer systems 107(a)-107(n) may be a standalone computer system or may comprise a local network of computers that is connected to public network 110 via a security appliance. Network traffic between computer systems 107(a)-107(n) and public network 110 passes through one of the security appliances 105(a)-105(n).

Security appliances 105(a)-105(n) disclosed herein enable end-users to participate in identifying and responding to malicious activity by interposing a security appliance in the network connection between the end-user's computer systems 107(a)-107(n) and public network 110. Computer system 107(a)-107(n) operate as if they were directly connected to pubic network 110, except data being communicated between computer system 107(a)-107(n) and public network 110 passes through a security appliance while in transit to its final destination. No special software and/or hardware needs to be installed in the end users' computer system 107(a)-107(n), thereby eliminating the risk to the government and/or private entities operating network 100 of installing hardware and/or software in end-users' computer systems.

Installing hardware and/or software in end-user's personal computers would place a burden on the government and/or private entities operating network 100 to provide technical support for issues arising with end-users' personal computers, and would place a burden on the end-users to trust that the software and/or hardware installed on their computer systems will not compromise the function of their computer systems (much less any personal information stored on the computer systems) and would require that the users keep their computer systems powered on and connected to the network all the time. Installing software and/or hardware on privately owned computer systems might also raise issue of violation of civil liberties and/or criminal statutes. Cyber criminals, of course, are not concerned about such issues when they take control of privately owned personal computers for various nefarious purposes, but the government or private entities making use of privately owned personal computer systems to fight back against botnets and other cybercrime activities would be subjected to legal and judicial scrutiny. Implementing the security appliances as standalone devices avoids these concerns. A malfunctioning security appliance may merely be disconnected or bypassed by an end user without any adverse effects on the end user's computer system.

According to embodiments of the present invention, security appliances 105(a)-105(n) may be configured to exchange data in a peer to peer fashion using public network 110. For example, security appliances 105(a)-105(n) may exchange information about conditions on various parts of public network 110, information regarding potential threats, and/or command protocols from management systems 102. Data exchanged between security appliances may be protected by various encryption methods known to the art to enable the security appliances to communicate securely across public network 110. According to an embodiment of the present invention, each security appliance may be provided with an independently verifiable security certificate that may be used to validate that data communicated from the security appliance. Security appliances 105(a)-105(n) may each be assigned a unique serial number at the time that the device is manufactured and that is physically integrated into a trusted component of the device that resists physical alterations and modification via electronic attacks.

Security appliances, such as security appliances 105(a)-105(n), may be mass marketed to millions of end users for installation of the device between their home network and their Internet connection. The government and/or a private entities may subsidize the cost of the devices (making the device free or available to end users at a discounted rate) to encourage end users to install the security appliances in exchange for the security appliances being able to make use of at least a small portion of the bandwidth of each end user's Internet connection. In exchange for being able to utilize a portion of the bandwidth of each end user's Internet connection, the security appliance provides various protection mechanisms that directly benefit the end user, such as a firewall, anti-virus protection, anti-spam protection, and/or other protection mechanisms that would make it more difficult for cyber criminals to take control of computer systems protected by the appliances. As well, these appliances may perform other functions of use to the user such as web browsing acceleration, etc. The appliance would not require maintenance or control by the end user. The appliance may be configured to automatically receive any necessary updates via the Internet from a secure data source, and if the appliance should malfunction and negatively affect the performance of the consumer's personal computer (for example, by interfering with traffic to and from the Internet) the security appliance may be easily removed or bypassed by the end user.

Management systems 102 comprise distributed control systems that send and/or receive data to security appliances 105(a)-105(n). Management systems 102 are preferably widely distributed at different geographical locations and are assigned different network addresses to thwart denial of service (DOS) and other types of attacks that may cripple the management systems 102. Management systems 102 may send data and/or commands to security appliances 105(a)-105(n) via public network 110 and receive data from security appliances 105(a)-105(n) via public network 110. The data and/or commands send to security appliances 105(a)-105(n) by management systems 102 may be secured in various ways to prevent the data and/or commands from unauthorized access while the data and/or commands is traversing public network 110. For example, various tunneling protocols may be used to communicate data between management systems 102 and security appliances 105(a)-105(n). Furthermore, data transmitted between management systems 102 and security appliances 105(a)-105(n) may be encrypted and/or secured using security certificates from Trusted Signature Authority 106 that may be used to independently verify the identity of the origin of the data. This relationship is shown as a dashed line in FIG. 1 because some out of channel method requiring physical access (such as at manufacture or through a smart card may be used to install the verification system into the appliances 105. Management systems 102 may also assess a current threat level for each security appliance 105(a)-105(n) to be used determine the amount of bandwidth and/or other resources that each security appliance 105(a)-105(n) may utilize.

Embodiments of the present invention may be used in cooperation with existing programs for fighting cybercrime. For example, management systems 102 can cooperate with one or more partner management systems 140 for fighting cybercrime. Partner management system 140 monitors data exchanged between a plurality of computer systems 150 and public network 110, and may be configured to perform various offensive and/or defensive actions in response to a cyber attack by malicious entities.

In an embodiment, partner management system 140 may comprise one or more computer systems of the “Einstein” program operated by the United States Computer Emergency Readiness Team (US-CERT), a partnership between the United States Department of Homeland Security and the public and private sectors. The Einstein program is voluntary program for United States government agencies that provides participating agencies with an automated process for collecting, correlating, analyzing and sharing computer security information among various federal government agencies, enabling cross-agency security incidents to be identified. The Einstein system is separately controlled by US-CERT, but may be configured to exchange information with management systems 102. For example, management systems 102 may be configured to communicate information regarding threats identified on the public network 110 to the Einstein system. Likewise, the Einstein system may provide management systems 102 with information regarding threats that have been identified by the Einstein system.

Malware control systems 120 comprise one or more computer systems controlled by cybercriminals for use in mounting attacks on computer systems and for spreading malicious code, such as worms or viruses, that when executed may damage or take control of infected computer systems. Malicious nodes 130 comprise one or more computer systems under control of the malware control systems 120.

In an embodiment, malware control systems 120 comprise botnet controllers used to control a botnet and malicious nodes 130 comprise zombie computer systems whose behavior may be remotely controlled by the botnet controllers. For example, a botnet controller may issue commands to zombie computer systems to execute a denial of service (DOS) attack on a particular computer system or systems. A botnet controller may also issue commands to zombie computer systems to generate spam email messages or to distribute malicious code such as a virus or a worm that attempts to compromise additional computer systems that may become zombie computers under control of the botnet. Security appliances 105(a)-105(n) attempt to identify and block traffic originating from malware control systems 120 and malicious nodes 130 from reaching computer systems 107(a)-107(n).

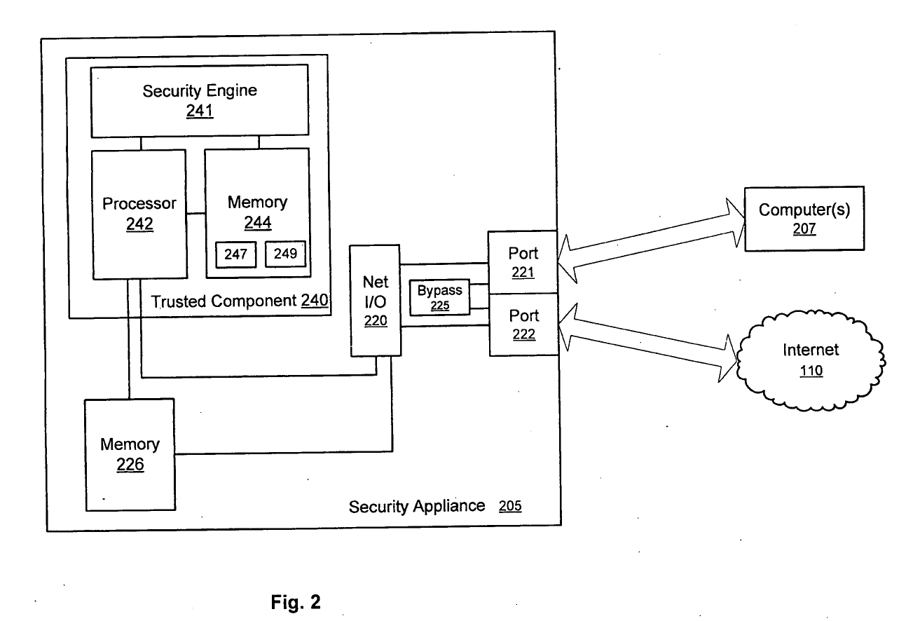

FIG. 2 is a block diagram of a security appliance 205 that may be distributed across a network, such as security appliances 105(a)-105(n) of network 100 described above, according to an embodiment of the present invention. Security appliance 205 not only provides protection to computer or computer systems 207, but may also provide protection to other computer systems on public network 110. Should an attacker successfully compromise computer system 207, security appliance 205 would prevent the attacker from using computer system 207 to mount additional attacks on other computer systems on network 110 by blocking attacks emanating from computer system 207.

According to an embodiment, security appliance 205 further comprises a self-test that may be used to determine whether the device is working properly and has not been compromised by an attacker. All transactions with the device are securely authenticated, using only public keys, and all control information may be encrypted using rapidly changing traffic keys. Security appliance 205 uses key management protocols that are scalable up to millions of units, with a high rate of turnover. For example, all code and data updates (including signatures, patterns, date, etc.) used by the security appliance are cryptographically authenticated to ensure that an attacker cannot pose as management systems 102 in order to provide malicious data and/or codes to security appliances 205 that would enable the attacker to compromise security appliance 205 and/or other security appliances on the network. The cryptographic algorithms used by the security appliance may be programmable (via secure authenticated transactions). Furthermore, the security appliance includes a fail-safe mode or modes (e.g. fully blocking or fully open), upon detection of a self-test failure.

Critical functions of the security appliance are contained in a high-assurance partition, trusted component 240. According to some embodiments, the trusted component 240 comprises a tamper-resistant module that prevents physical manipulation of information and components of the trusted component 240. The relationship between the trusted partition and the other processing section of the appliance may be similar to that of the trusted platform module (TPM) with the personal computer. For example, all boot paths may be controlled, and tamper detection and self-testing may also be provided to ensure integrity of security appliance 205.

Trusted component includes processor 242, memory 244, and security engine 241. Processor 242 executes instructions 247 included in memory 244. The instructions determine the functions of security appliance 205, and thus, external access to the instructions in memory 244 should be severely limited or entirely precluded to ensure that the function of security appliance 205 cannot easily compromised by attacks originating from public network 110, such as from a botnet, or through direct physical manipulation of security application 205. Security engine 241 verifies that the components of trusted component 240 have not been compromised and are functioning correctly. Security engine 241 has control over processor 242 and memory 244 and is configured to verify that processor 242 is functioning correctly and that the contents of memory 244 have not been comprised. Security engine 241 uses strong cryptographic methods to verify that the

Trusted component 240 is manufactured under secure conditions by a trusted manufacturer to ensure the authenticity of the instructions included in memory 244. Each trusted component 240 may also include a unique serial number that may be used to identify a security appliance 205 that includes the trusted component. Furthermore, trusted component 240 may include a public key certificate that includes a digital signature that binds a public key to a particular security appliance 205. The manufacturer of the trusted component may act as the certification authority that issues the certificates, or the manufacture may use a third-party certificate authority to certify the authenticity of the certificates, such as trusted signature authority 106. To ensure that the security of the digital signature, trusted signature authority 106 does not communicate the digital signature to the manufacturer of the trusted component via public network 110. Instead, the digital signature may be provided to the manufacturer of the trusted component via various secure methods. In some embodiments, the digital signature may be provided on a physical medium, such as a USB key flash drive or other tangible medium that can be physically secured and transported from trusted signature authority 106 to the trusted component manufacturer. In some embodiments, a secure, encrypted network connection from trusted signature authority 106 to the trusted component manufacturer.

According to an embodiment of the present invention, the architecture of security appliance 205 may be based upon the Programmable, Scalable Information Assurance Model (PSIAM) architecture by ViaSat, Incorporated.

Trusted component 240 may also include a “signature database” 249 stored in memory 244 or in a secondary memory within trusted component 240 (not shown). Signature database 249 may include signatures used for identifying threats such as viruses, worms, and/or spam email messages. The contents of signature database may be updated through control messages from management systems 102 or via peer to peer connections between security appliances.

Security appliance 205 includes port 221 which is coupled to a computer system 207 and a port 222 which is coupled to public network 110. Network interface 220 is coupled to ports 221 and 222. For example, according to an embodiment, the port 221 may comprise an Ethernet port and security appliance 205 is connected to computer system 207 via an Ethernet connection. One skilled in the art will recognize that other types of network connections and/or protocols, both wired and wireless, may be used to provide communications between security appliance 205 and computer system 207 or network 110. One skilled in the art will also recognize that security appliance 205 may include additional ports for connecting additional computer systems 207.

Security appliance 205 may include a bypass 225 that enables a user to bypass security device 205. Bypassing security appliance 205 enables data to be directly exchanged between computer system 207 and public network 110. For example, bypass 225 might comprise a button or a switch located on the housing of security appliance 205 that a user may use to manually switch security appliance 205 from an “active” mode, where security appliance 205 monitors and may take action on data being communicated between public network 110 and computer system 207, to a “bypass” mode where data communicated between public network 110 and computer system 207 passes through security appliance 205 without security appliance 205 monitoring or taking action on the data. One skilled in the art will recognize that bypass 205 may be implemented using various other types of switching means known to the art, including a default bypass condition when power is not applied to the appliance 205.

Network interface 220 is configured to receive packets of data from ports 221 and 222 and is likewise configured to transmit data to computer system 207 via port 221 and to public network 110 via port 222. Network interface 220 also may also store data received from ports 221 and 222 in memory 226 and may communicate data to and receive commands from processor 242 of trusted component 242. Processor 242 may access the data stored in memory 226 and/or write data to memory 226. For example, processor 242 may access data stored in memory 226 when performing various security functions, such as examining data packets to identify spam message, viruses, worms, and/or other threats.

Network interface 220 is also configured to route messages received from management systems 102 via public network 110 to trusted component 242. The messages may be directly communicated to processor 242 or may be written to memory 226.

In addition to the security appliance's function providing standard security functions, such as those described above, the appliance may also provide significant cyber-terrorism countermeasures. Potentially millions of security appliances installed widely across the Internet in consumer's home and/or business may be harnessed to provide a number of capabilities for dealing with threats by cyber-criminals, including: (1) diagnostic functionality to identify threats, (2) preventative functionality to stop cyber-criminals from taking control of more personal computers to expand a botnet, (3) defensive counter-measures to try to stop an attack, and (4) offensive measures to try to stop a botnet by attacking the botnet.

Diagnostic capabilities that far surpass existing techniques, such as network sniffers, may be included in the security appliance. Security appliances may work cooperatively (peer-to-peer communications) to identify traffic patterns across the Internet to provide the potential to recognize and thwart new attacks by quickly responding. For example, via the peer-to-peer distribution, an entire network of security appliances may be updated with new signatures or patterns for identifying network traffic related to cyber-criminal activity. Various information gathered by the security appliances may be shared among the security appliances enabling a network of the security appliances to identify information that may appear innocent, or mildly suspicious in small quantities, but may be more readily identified as serious threats, if found in large quantities.

Preventative capabilities of the security appliance might include a standard suite of security protection functions: firewall, anti-virus, anti-spam, anti-phishing. The security appliance may also update itself almost instantaneously (via peer-to-peer updating), and may prevent worm spread as fast or faster than the worm spread rate since the security appliance may provide real-time recognition of attacks, enabling the security appliance network to prevent significant levels of propagation. The security appliance network can work in conjunction with Internet backbone devices to provide network-wide defenses.

Defensive countermeasures to botnets are made possible by the network of security appliances. A network of security appliances should provide sufficient resources to recognize and go after the sources of attacks. If nothing else, simple denial of service counter-attacks on all control sites should effectively shut down a botnet. More sophisticated counter-attack techniques can be deployed once the control structures of the botnets are understood. For example, the zombie machines comprising the botnet may be instructed to engage in the counter attack themselves. Offensive countermeasures may also be taken against a botnet once a source of a threat has been identified.

The form and function of the device according to one embodiment would be a small appliance. For example, the security appliance may be implemented as a “bump in the wire” with an Ethernet input and an Ethernet output. Some embodiments may include a multiple port switch, such as a 4-port switch. Other configurations may be provided depending upon market forces.

The security appliance requires no configuration by the end user. The user simply needs to know how to connect the device to a public network (such as the internet) and to a computer system or local network, and how to disconnect the device should the device malfunction or the user wish to remove it. An optional user interface may be included in some implementations to provide the user with information about how much bandwidth the device is consuming and/or other information such as the types of attacks that the device has prevented. For example, the user interface might display a web page that indicates that the device has blocked 350 spam messages, 10 potential viruses, and 120 attempts to propagate network worms.

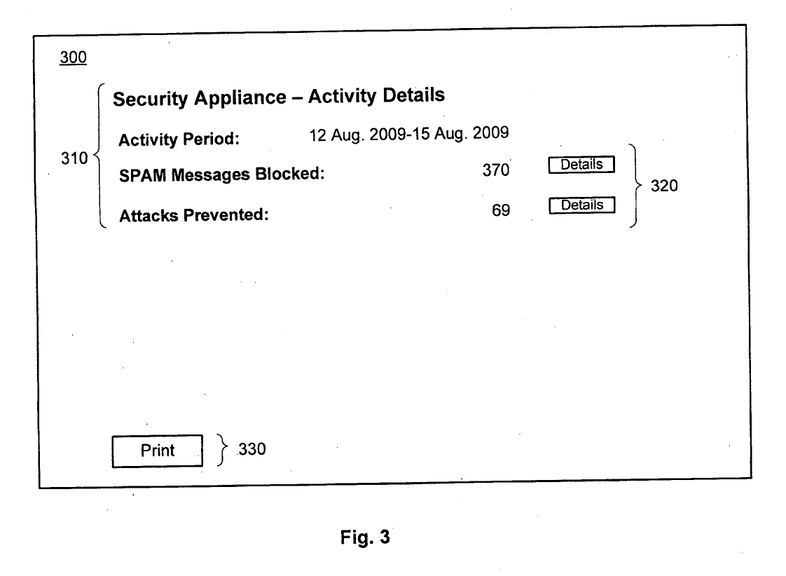

FIG. 3 is a block diagram illustrating a user interface 300 for tracking activity of a security appliance 205 according to an embodiment of the present invention. Interface 300 may comprise a webpage accessible from conventional web browser software available on a computer system protected by a security appliance, such as computer systems 207. According to an embodiment of the present invention, a user of a computer system protected by a security appliance may enter a special universal resource locator (URL) into the web browser software on an end user's computer system. Security appliance 205 recognizes this URL in a stream of data received from the user's computer system, generates the data for the webpage representing interface 300, and transmits the information to the user's computer system via port 221.

Interface 300 includes an “activity details” section 310 that provides a summary of the activity for a predetermined period of time. For example, the security appliance may be configured to generate a summary of activity for the past week. Activity details section 310 may include details such as the number of spam messages blocked, the number of viruses blocked, and/or the number of other types of attacked blocked for the period of time covered by the summary data. According to some embodiments of the present invention, interface 300 may include detail buttons or hyperlinks 320 that, when activated, provide a more detailed breakdown of the information provided on interface 300. For example, if the details button next to the “SPAM messages blocked” line item were clicked, an interface displaying a detailed breakdown of the SPAM messages blocked would be generated by the security appliance and provided to the user's computer system for display to the user. The detailed breakdown of the spam messages might include information from the headers of the messages that were blocked, such as sender, date and timestamp information, and subject. Similarly, if the details button next to the “Attacks Prevented” line item were clicked, the security appliance would generate an interface comprising a detailed breakdown of the types of attacks blocked by the security appliance, such as worms, virus, and/or other types of attacks. Print button 330 may be implemented to give the user the capability to easily generate a printed report.

The security appliance may include multiple functional modes. These modes are not mutually exclusive. For example, according to an embodiment, a security appliance might include the following modes: (1) security appliance mode, (2) standalone defender mode, (3) cooperative defender mode, and (4) controlled defender mode.

In security appliance mode, security appliance 205 may be configured to perform one or more typical security functions provided by conventional security appliances, such as anti-virus, firewall, anti-spam, and/or other types of protection. The security appliance mode may be operating concurrently with other modes to continue to provide conventional security features while providing augmented security features provided by other modes.

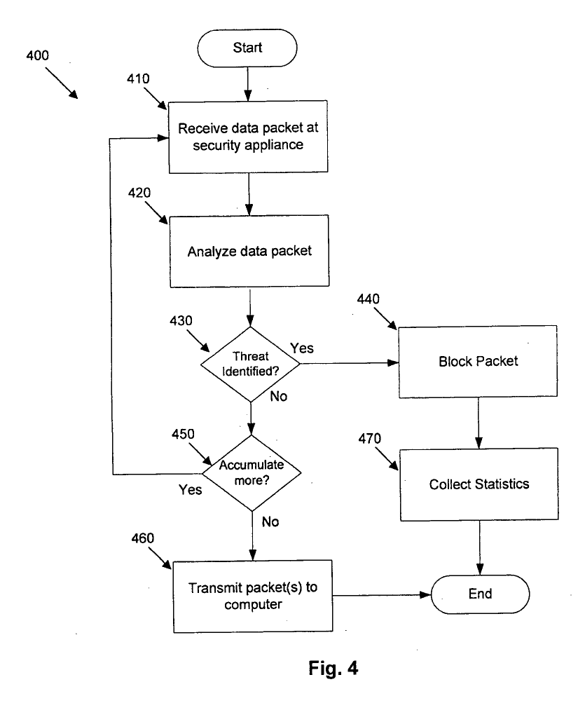

FIG. 4 is a high level flow diagram of a method 400 for analyzing packets in a security appliance operating in a standalone security appliance mode according to an embodiment of the present invention. In standalone security appliance mode, the security appliance may perform basic security services such as spam blocking, firewall, and virus detection. If a threat is detected, data packets comprising the threat may be blocked to prevent the threat from spreading to and compromising other computer systems. Method 400 begins with step 410 where a data packet is received at the security appliance. The data packet may originate either from public network 110 or from a computer system, such as computer system 207. The incoming data packet is received by network interface 220 of security appliance 205 and may be stored in memory 226 or provided to trusted component 240 for processing. At step 420, trusted component 240 analyzes the data packet determine whether the data packet is indicative of a threat. Trusted component 240 may compare the contents of the data packet to signatures of known threats in signature database 249. For example, security apparatus 205 may compare the network address of the origin of a data packet to a list of blacklisted servers to determine whether a packet of data should be blocked.

At step 430, a determination is made whether a threat was identified while analyzing the data packet in step 420. If a threat was identified, method 400 proceeds to step 440, where the data packet may be blocked. If the packet was directed to computer system 207, blocking the data packet may prevent computer system 207 from being compromised by the malicious content being transmitted to computer system 207. Otherwise, computer system 207 may have been compromised and fall under the control of a botnet and/or otherwise be used to further the goals of cybercriminals. If the packet that was blocked was directed to public network 110, this may indicate that computer system 207 has been compromised and may be under the control of a botnet and/or is otherwise being used to generate malicious content (such as worms or viruses). For example, computer system 207 may have become infected prior to the security appliance being interposed between the computer system and the public network, or may have been infected through other means, such as through a virus introduced on a physical media such as a CD-ROM or a flash drive. After blocking the packet in step 440, statistics regarding the threat are collected and stored in security appliance 105. In an embodiment, the statistics collected are transmitted to management systems 102 after being collected. In another embodiment, security appliance 105 may store the statistics and transmit collected and stored statistics at regular intervals. In yet another embodiment, management systems 102 may periodically request statistics data from security appliances 105. After collecting the statistics, method 400 terminates. However, additional packets may be received and processed according to method 400.

If a determination was made that a threat was not detected at step 430, method 400 continues with step 450. At step 450, a determination is made whether additional packets may need to be accumulated in order to determine whether a threat is present. In order to detect some sorts of threats, it may be necessary to evaluate multiple packets of data. For example, an email message may be broken in a multiple data packets, and without examining multiple packets, it may not be possible for the security appliance to make a determination as to whether a message should be tagged as spam. Therefore, the security appliance may accumulate multiple data packets in a buffer, such as in memory 226 before making a determination as to whether to take action or to transmit the data packets to computer system 207.

If a determination is made at step 450 that multiple data packets need to be accumulated, method 400 returns to step 410 where the device waits to receive another data packet, and will perform an analysis on the newly received data packet and any accumulated data packets in step 420. Instead, if a determination is made at step 450 that multiple data packets do not need to be accumulated, method 400 proceeds to step 460, where the data packet and any other accumulated data packets are transmitted to the intended recipient of the data packet (computer system 207 or public network 110) and method 400 terminates.

In standalone defender mode, security appliance 205 may independently support a defense mission based upon a set of rules and/or patterns for identifying threats. These rules and/or patterns may be stored in signature database 249. According to one embodiment of the present invention, security appliance 205, while operating in standalone mode, may send activity notifications and block control and/or attack packets to and/or from zombie devices. Additional defenses may also be provided based upon the rules and/or patterns provided to the security appliance.

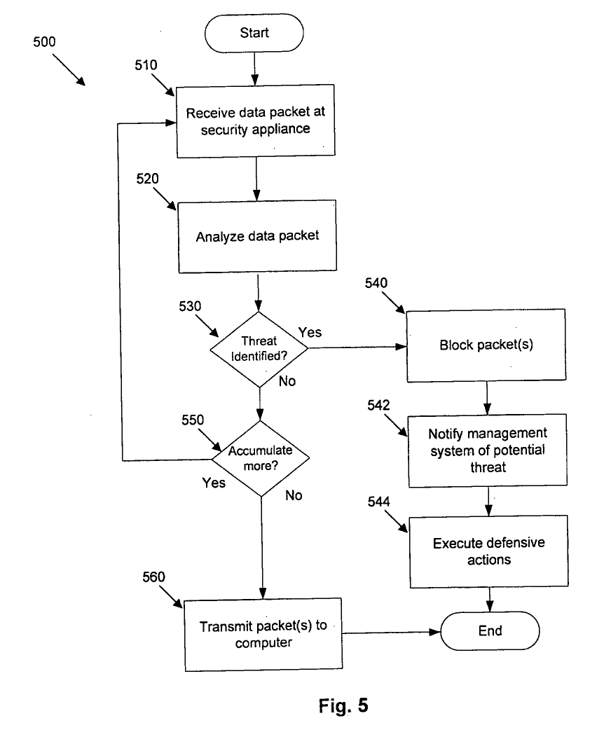

FIG. 5 is a high level flow diagram of a method 500 for analyzing packets in a security appliance operating in a managed defender mode according to an embodiment of the present invention. In managed defender mode, the security appliance may report threats to management systems 102 and take additional defensive actions. Method 500 begins with step 510 where a data packet is received at the security appliance (similar to step 410 describe above). The data packet may originate either from public network 110 or from a computer system, such as computer system 207. At step 520, trusted component 240 analyzes the data packet determine whether the data packet is indicative of a threat. Trusted component 240 may compare the contents of the data packet to signatures of known threats in signature database 249.

At step 530, a determination is made whether a threat was identified while analyzing the data packet in step 530. If a threat was identified, method 500 proceeds to step 540, where the data packet may be blocked. Method 500 then proceeds to step 542. At step 542, the system defender notifies management systems 102 of the potential threat that has been identified. The management systems 102 may use this information to formulate a response to the potential threat, which may include a swarm defense and/or offense where multiple security appliances are commanded by the management systems 102 to work in concert to help diffuse a threat.

At step 544, additional defensive actions may be taken by the security appliance in response to the threat detected. For example, the security appliance may block all packets received from a certain source, or all packets of a certain type to prevent threat from compromising computer system 507, or in the event that computer system 507 has already been compromised, preventing the threat from spreading. As an example, a botnet may launch a denial of service attack against a computer system by saturating the target computer system with service requests so that the computer system cannot adequately respond to legitimate requests to use the computer system's services.

If a determination was made that a threat was not detected at step 530, method 500 continues with step 550. At step 550, (similar to step 450 described above) a determination is made whether additional packets need to be accumulated in order to determine whether a threat is present.

If a determination is made at step 550 that multiple data packets need to be accumulated, method 500 returns to step 510 where the device waits to receive another data packet, and will perform an analysis on the newly received data packet and any accumulated data packets in step 520. Instead, if a determination is made at step 550 that multiple data packets do not need to be accumulated, method 500 proceeds to step 560, where the data packet and any other accumulated data packets are transmitted to the intended recipient of the data packet (computer system 207 or public network 110) and method 500 terminates.

In cooperative defender mode, security appliance 205 may perform one or more functions based upon communications with neighboring peer device (other security appliances) to perform coordinated defenses. For example, in cooperative defender mode, security appliance 205, working in conjunction with other peer devices, may perform pattern recognition, probe suspicious network sources, perform an auto denial of service (DOS) attack on cyber terrorist control points (used to control zombie computers), propagate friendly worms/viruses to enemy computers, and/or perform other defensive functions in conjunction with peer devices. By working in conjunction with peer devices, security appliances are able to react extremely quickly to attacks.

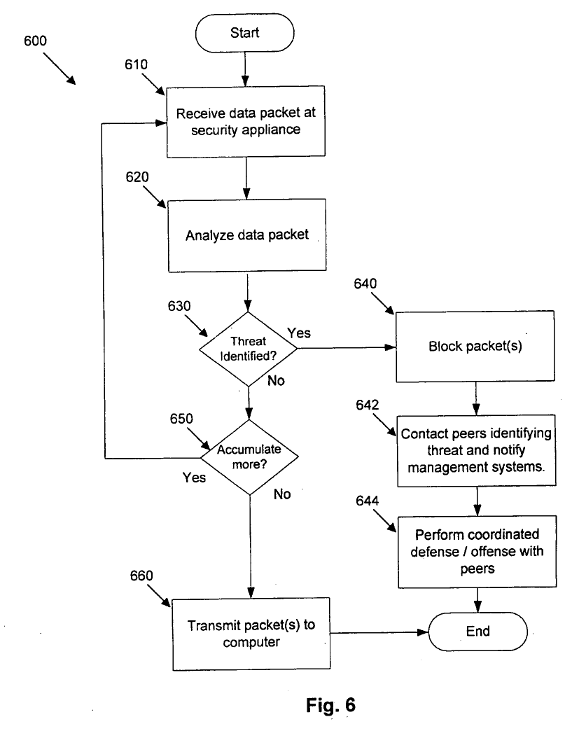

FIG. 6 is a high level flow diagram of a method 600 for analyzing packets in a security appliance operating in a cooperative defender mode according to an embodiment of the present invention. In cooperative defender mode, the security appliance may report threats to management systems 102 and to neighboring security appliances via peer to peer connections. The security appliance may also take additional defensive and/or offensive actions either alone or in conjunction with other security appliances. Method 600 begins with step 610 where a data packet is received at the security appliance (similar to step 410 describe above). The data packet may originate either from public network 110 or from a computer system, such as computer system 207. At step 620, trusted component 240 analyzes the data packet determine whether the data packet is indicative of a threat. Trusted component 240 may compare the contents of the data packet to signatures of known threats in signature database 249.

At step 630, a determination is made whether a threat was identified while analyzing the data packet in step 630. If a threat was identified, method 600 proceeds to step 640, where the data packet may be blocked. Method 500 then proceeds to step 642. At step 642, the system defender notifies management systems 102 of the potential threat that has been identified and may also notify neighboring security defenders of the potential threat. The management systems 102 may use this information to formulate a response to the potential threat, which may include a swarm defense and/or offense where multiple security appliances are commanded by the management systems 102 to work in concert to help diffuse a threat. The neighboring security appliances may exchange potential threat information, and based upon this information, may take one or more defensive and/or offensive actions either alone or in conjunction with other security appliances. If a threat is identified, the security appliances may perform swarm defensive and/or offensive actions (step 644). For example, the security defenders may launch a DOS attack against a botnet controller or zombie computers from which threat has originated. The swarm defensive and/or offensive actions provides power of response in numbers to help quash threat. The defensive and/or offensive actions taken may be directed by management systems 102 or may be determined by the security appliances working together.

If a determination was made that a threat was not detected at step 630, method 600 continues with step 650. At step 650, (similar to step 450 described above) a determination is made whether additional packets need to be accumulated in order to determine whether a threat is present.

If a determination is made at step 650 that multiple data packets need to be accumulated, method 600 returns to step 610 where the device waits to receive another data packet, and will perform an analysis on the newly received data packet and any accumulated data packets in step 620. Instead, if a determination is made at step 650 that multiple data packets do not need to be accumulated, method 600 proceeds to step 660, where the data packet and any other accumulated data packets are transmitted to the intended recipient of the data packet (computer system 207 or public network 110) and method 600 terminates.

In controlled defender mode, security appliance 205 may perform all of the functions of the other modes described above, but while operating under the control of a management network that controls a swarm of security appliances. Placing the swarm under control of the management network enables the swarm to be used in conjunction with other existing infrastructure for fighting cyber-crime. The swarm may be instructed to perform specialty tasks on behalf of the management system. Control-path anonymity may also be supported via information forwarding through peer-to-peer connections between the security appliances that are part of the swarm.

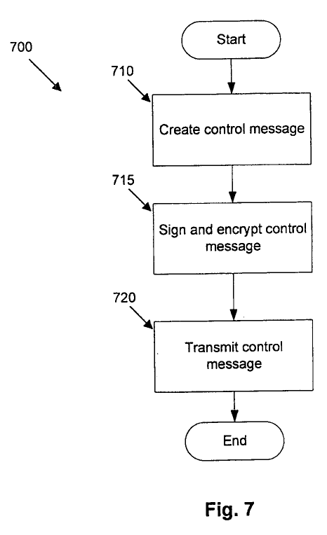

FIG. 7 is a high level flow diagram of a method for transmitting control commands to security appliances according to an embodiment of the present invention. In step 710, management systems 102 create a control message that includes one more control command instructing one or more security appliances 105 to perform one or more actions and/or data for the security appliances 105. Management systems 102 then signs and encrypts the control message (step 720). The control message is signed by management systems 102 through trusted signature authority 106 so that the origin of the control message can be verified by security appliances 105 receiving the signed messages. The signed message is also encrypted to ensure that contents of the control message cannot be intercepted and the contents of the messages monitored by cyber criminals. The signed and encrypted control message is then transmitted to security appliances 105 (step 720). In an embodiment, the message may be packetized and transmitted over the public network 110 using various paths to further ensure that even if some of the packets are intercepted and decrypted, the full contents of the message may not be reassembled.

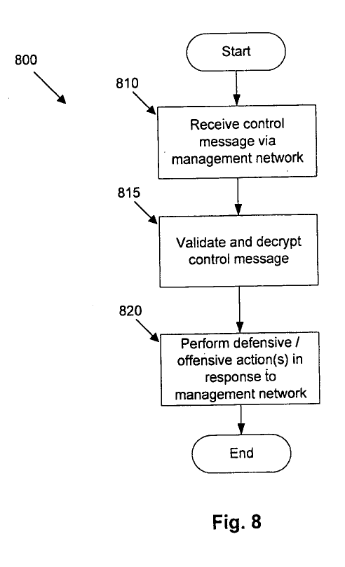

FIG. 8 is a high level flow diagram of a method 800 for operating a security appliance to respond to control commands from management servers 102 according to an embodiment of the present invention. Control commands may be sent in response to changes in threat level, thereby increasing the amount of resources that the device may consume. Control messages may also include data, such as updates to signatures of known threats to be stored in threat signature database 249. Control commands may also be used to instruct the security appliance to perform one or more defensive and/or offensive measures, either alone on in conjunction with other security defenders, in response to a potential threat. FIGS. 5 and 6, described above, illustrate methods of operating a security appliance to perform defensive and/or offensive actions.

At step 810, the security appliance receives a control message from the management systems 102 indicating that the security appliance should perform one or more offensive and/or defensive measures. The control message may be received via secure connection over public network 110, such as through the use of a tunneling protocol that encrypts the data during transit over non-secure public network 110.

At step 815, the security appliance validates the signature used to sign the control message and decrypts message. The signature used to sign the control message authenticates the origin of the message. A control message may originate from management systems 102 or from a peer security device in the case of peer to peer communications between devices. If the message is not properly signed or encrypted, this may indicate that the control message originated from a malicious source and will not be processed by the security appliance 105. In an embodiment, security appliance 105 may report the receipt of a improperly signed or encrypted message to management systems 102.

At step 820, the security appliance performs the offensive and/defensive actions specified in the control message if the message had a valid signature and was properly encrypted. If the control message included an update to the threat signatures, the data comprising threat signature database 249 may be updated in with data received from management systems 102. After completing step 820, process 800 terminates.

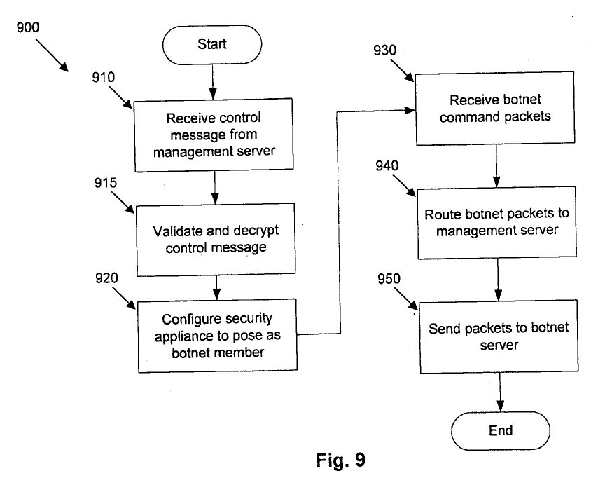

FIG. 9 is a high level flow diagram of a method 900 for operating a security appliance to pose as a computer that is a member of a botnet according to an embodiment of the present invention. Management systems 102 may send control commands one more security appliances 205 to configure the security appliances 205 to pose as a member of a botnet. By posing as a member of the botnet, a security appliance would be able to capture botnet control protocols and provide those protocols to the management systems 102 and would also be able to help identify attacks staged by malware control systems 120. According to an embodiment of the present invention, the management system may configure multiple security appliances 205 to pose as members of a botnet and to configure each security appliance 205 to have slightly different behavior in order to make detection difficult.

Method 900 begins with step 910, where security appliance 205 receives a control message from management servers 102 instructing security appliance 205 pose as a member of a botnet. The control message may include various information that security appliance 205 may use to pose as a botnet member, such as protocols used by botnet members to communicate with the malware control systems 120.

At step 915, the security appliance validates the signature used to sign the control message and decrypts the message. The signature used to sign the control message authenticates the origin of the message. A control message may originate from management systems 102 or from a peer security device in the case of peer to peer communications between devices. If the message is not properly signed or encrypted, this may indicate that the control message originated from a malicious source and will not be processed by the security appliance 105. In an embodiment, security appliance 105 may report the receipt of a improperly signed or encrypted message to management systems 102.

Method 900 continues with step 920 if the signature on the control message was valid and the message was successfully decrypted. Security appliance 205 is configured to operate as a botnet member. According to an embodiment of the present invention, security appliance 205 may be configured to transmit data to malware control systems 120 to identify the security appliance as a zombie computer. The amount of bandwidth and/or other resources dedicated to defensive and/or offensive actions taken by the security appliance may increase as a result of the commands to operate as a botnet member.

Method 900 continues with step 930, where security appliance 205 receives command packets from malware control systems 120. At step 940, security appliance routes information received from malware control systems 120 to management systems 102. Management systems 102 may use the information provided by security appliance 205 to identify botnet control protocols. At step 950, security appliance 205 may send information to malware control systems 120. This information may include false information and/or may be used to counterattack the bot net controllers.

According to an embodiment of the present invention, a security appliance device is provided that overlays national defense functions on top of a commercial resource. The security appliance is configured to be interposed between a computer system and a public network, such as the Internet, and wherein data communicated to the computer system from the public network passes through the security appliance before being provided to the computer system and data communicated to the Internet from the security appliance passes through the security appliance before being communicated to the public network. The security appliance may prevent data from the public network from reaching the computer system and/or data communicated from the computer system from reaching the public network if suspicious activity is detected.

The security appliance may comprise various components, such as a processor for executing various instructions, a persistent memory for storing data and/or instructions to be executed by the processor, a network interface for receiving data communications from the public network and from the computer system and for communicating data to the public network and the computer system. The critical functions of the security appliance may be contained in a high-assurance partition to protect the integrity of the security appliance (e.g. prevent takeover by a botnet through introduction of compromised code or through physical tampering). The security appliance also configured to receive secured and/or encrypted commands and/or data from secure network management system that provides instructions to security appliance to be executed by the security appliance. The security appliance includes configurable control mechanisms or control logic for restricting the amount of resources (bandwidth, processor cycles, memory) that may be consumed while executing defense-related functions. The amount of resources that may be consumed for defense-related functions may be based upon a current threat level.

According to another embodiment of the present invention, a security appliance is provided that is configured to operate in conjunction with peer security appliances to provide a swarm response to a viral outbreak. Detection of a viral vector prompts an immediate response by a security appliance and the peer security appliances to stop the outbreak of the virus before the virus spreads to additional computers. The security appliance is configured to receive messages from and to send messages to peer security appliances. The peer security appliances may be widely geographically distributed, and the messages to peer security appliances may be encrypted and secured for communication over a public network. The security appliance, upon detecting data indicative of a viral outbreak, is configured to generate a message to one or more peer security appliances, the message identifying the suspected threat. The security appliance is also configured, upon receiving a message indicative of a suspected threat, to perform one or actions in response to the threat. These actions may be performed by the security appliance alone or in conjunction with one or more peer devices.

According to another embodiment of the present invention, a security appliance is provided that may be configured to pose as a botnet member while remaining under control of a security management server. The security appliance poses as a member of the botnet and may be configured to capture data from a botnet controller and forward the captured information to the security management server for analysis. For example, the security appliance may be configured to capture botnet control protocols and to identify attacks and forward this information to the security management server for analysis. The security appliance may also be configured to receive one more commands to be performed as a countermeasure against the botnet controller. The security appliance may be implemented using similar components and may include similar features as the embodiment described above. Multiple security appliances may be configured to pose as members of a botnet, and each security device may be individually configured to have slightly different behavior in order to make detection of the security appliances posing as botnet members more difficult.

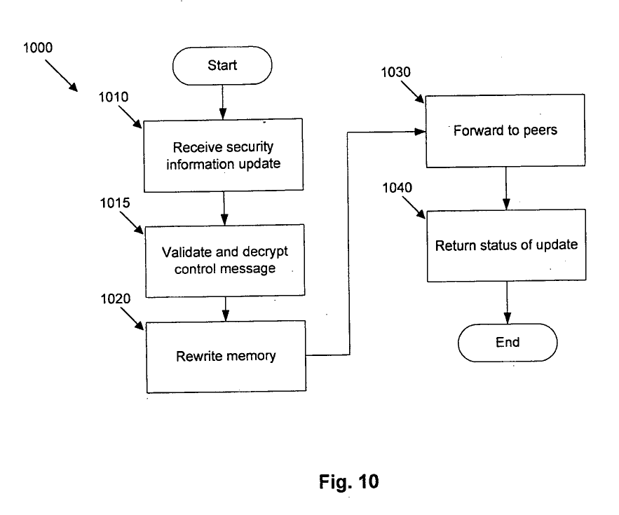

FIG. 10 is a high level flow diagram of a method 1000 for updating the security information of a security appliance according to an embodiment of the present invention. Method 1000 begins with step 1010, where security appliance 205 receives a control message from management servers 102 instructing security appliance 205 to update the security information stored in trusted component 240. A control message may originate from management systems 102 or from a peer security device in the case of peer to peer communications between devices. For example, the control message may include updates to signature data 249 that includes information used to identify various threats, updates to control instructions 247 and/or configuration data stored in memory 244.

At step 1015, the security appliance validates the signature used to sign the control message and decrypts message. The signature used to sign the control message authenticates the origin of the message. If the message is not properly signed or encrypted, this may indicate that the control message originated from a malicious source and will not be processed by the security appliance 105. In an embodiment, security appliance 105 may report the receipt of a improperly signed or encrypted message to management systems 102.

Method 1000 continues with step 1020 if the signature on the control message was valid and the message was successfully decrypted. In step 1020, the data and or instructions are written to memory 244.

At step 1030, a signed and encrypted copy of the control message may be transmitted to one or more peer security appliances 105 via public network 110.

At step 1040, security appliance 105 transmits a signed and encrypted message to management systems 102 indicating whether the update was successful.

Embodiments of the present invention provide a security appliance that enables a computer system to participate in a public network without being vulnerable to attacks as a result of that participation. Various hardware protection mechanisms and/or software or firmware protections may be included in the security appliance to enable the computer system to fully participate in bidirectional network communications, while limiting the probability that the computer system will be subject to attacks or be taken over as a zombie system included in a botnet.

Having described several embodiments, it will be recognized by those skilled in the art that various modifications, alternative constructions, and equivalents may be used without departing from the spirit of the invention. For example, the above elements may merely be a component of a larger system, wherein other rules may take precedence over or otherwise modify the application of the invention. Accordingly, the above description should not be taken as limiting the scope of the invention, which is defined in the following claims.

What is claimed is:

1. A network security appliance interposed between a computer system and a public network, the network security appliance being configured to:
receive, via a secure connection over the public network, digitally signed and encrypted threat information for identifying malicious content and activities;
validate the signature of the security related information;
decrypt the security related information;
update a secured memory of the network security appliance with the threat information; and
analyze data traffic between the computer system and the public network to identify malicious content using the threat information.

2. The network security appliance of claim 1 wherein if malicious content is identified, blocking data traffic between the computer system and the public network.

3. The network security appliance of claim 1, wherein the threat information is received from another network security appliance via a secure peer to peer connection over the public network.

4. The network security appliance of claim 3, wherein the threat information is received from a management server, the management server being configured to provide threat information for identifying malicious content and activities to a plurality of network security appliance.

5. The network security appliance of claim 1, wherein the network security appliance is configured to transmit, via a secure connection over the public network, security related information to at least one other network security appliance and a management server.

6. The network security appliance of claim 1, wherein the network security appliance includes a trusted component, the trusted component comprising:
a processor; and
a memory for storing commands to be executed by the processor and threat information for identifying malicious content and activities, wherein the trusted component is configured to prevent unauthorized access to the processor and the memory.

7. The network security appliance of claim 6, wherein the trusted component is configured to prevent physical tampering.

8. A method of operating a network security appliance, the network security appliance being interposed between a computer system and a public network, the method comprising:
receiving, via a secure connection over the public network, digitally signed and encrypted threat information for identifying malicious content and activities;
validating the signature of the security related information;
decrypting the security related information;
updating a secured memory of the network security appliance with the threat information; and
analyzing data traffic between the computer system and the public network to identify malicious content using the threat information.

9. The method of claim 8 further comprising:
performing one or more remedial measures if malicious content is detected.

10. The method of claim 9 wherein performing the one or more remedial measures further comprises:
notifying a management system of a potential threat via a secure connection over the public network, the management system being configured to provide threat information to a plurality of network security appliances.

11. The method of claim 9 wherein performing the one or more remedial measures further comprises:
executing one or more defensive actions.

12. The method of claim 11 wherein executing one or more defensive actions further comprises:
blocking all data packets from a source of the malicious content.

13. The method of claim 11 wherein executing one or more defensive actions further comprises:
blocking all data packets of a particular type associated with the malicious content.

14. The method of claim 11 wherein executing one or more defensive actions further comprises:
performing pattern recognition functions in cooperation with a plurality of other network security devices to identify a source of a threat.

15. The method of claim 9 wherein performing the one or more remedial measures further comprises:
executing one or more offensive actions.

16. The method of claim 15 wherein executing one or more offensive actions further comprises:
participating in a denial of service attack against the source of the malicious content with a plurality of other network security appliances.

17. The method of claim 15 wherein executing one or more offensive actions further comprises:
propagating friendly malicious content to the source of the malicious content, the friendly malicious content being configured to damage or disable the source of the malicious content.

18. The method of claim 8 wherein analyzing the data packet for malicious content further comprises:
accumulating multiple packets of data at the network security application before analyzing the data packets using the network security appliance to determine whether a threat exists; and
blocking the multiple packets of data if malicious content is identified; and
transmitting the multiple packets of data to a target destination if no malicious content is identified.

19. A method of operating a network security appliance, the network security appliance being interposed between a computer system and a public network, the method comprising:
receiving a control message from a management server, the management server being configured to provide security related information identifying specific threats to a plurality of network security appliances;
performing one or more security-related actions in response to the control message received from the management server.

20. The method of claim 19 wherein a performing one or more security-related actions in response to the control message received from the management server further comprises:
configuring the network security appliance to transmit packets to a botnet server;
receiving command packets from the botnet server; and
routing the command packets to the management server for analysis.

21. The method of claim 20 wherein in response to routing the command packets to the management server for analysis:
receiving from the management server one or more data packets comprising decoy information to be provided by the botnet server; and
transmitting the data packets comprising decoy information to the botnet server.

22. A computer network comprising:
a management system coupled to a public network;
a plurality of network security appliances, each network security appliance being interposed between a computer system and the public network;
wherein the management server is configured transmit threat information and control commands to the plurality of network security appliances, and
wherein the management server is further configured to receive threat information and network data from the plurality of network security appliances.

23. The computer network of claim 22 wherein the management server is configured to receive threat information from a partner management system and to transmit threat to the partner management system.

24. The computer network of claim 22 wherein the management system is configured to transmit a control command to one or more network security device instructing one or more network security device to execute a defensive action against a cyber threat.

25. The computer network of claim 22 wherein the management system is configured to transmit a control command to one or more network security device instructing the one or more network security device to execute an offensive action against a cyber threat.

26. The computer network of claim 22 wherein the management system is configured to transmit a control command to one or more network security device instructing the one or more network security device to configure the one or more network security device to pose as a zombie computer under the control of a botnet server.

27. The computer network of claim 26 where in response to receiving the command from the management server to pose as a zombie computer under the control of a botnet server, the one or more network security device is configured to:
transmit data packets to the botnet server identifying the at least one of the plurality of network security devices as a zombie computer under control of the botnet server;
receiving command packets from the botnet server; and
routing the command packets to the management server for analysis.
